(19) United States
(12) Patent Application Publication
(10) Pub. No.: US 2015/0017455 A1
(43) Pub. Date: Jan. 15, 2015

(54) Composition

(71) Applicant: Fresh Formulations Limited, Lancashire (GB)

(72) Inventor: Keith MacGregor, Yorkshire (GB)

(21) Appl. No.: 14/117,227

(22) PCT Filed: May 14, 2012
(86) PCT No.: PCT/GB12/51064

§ 371 Date: Oct. 2, 2014

(30) Foreign Application Priority Data
May 13, 2011 (GB) 1107997.7

(51) Int. Cl. C09D 5/16; B05D 5/00

(52) U.S. Cl. CPC C09D 5/1675; B05D 5/00
USPC 428/447; 106/287.14; 427/387

(57) ABSTRACT

A coating composition for coating an underwater structure which is subject to damage from water, the coating composition comprising (1) a cross-linkable polysiloxane; (2) a silane cross-linking agent; and (3) fumed silica.

The present invention relates to a coating composition applied to a surface to increase its hydrophobicity and/or to prevent or reduce contamination of the surface. Such contamination may include biological, microbiological, chemical, and/or radiological contamination.

Fouling on the hulls of water-borne vessels can reduce their performance, in particular their speed, acceleration and fuel efficiency, as well as in some cases hasten surface corrosion, which can encourage further fouling.

Accordingly many efforts have been made to reduce fouling. In many cases these have involved applying a coating that repels marine fouling organisms and/or slime or reduces their ability to adhere to the surface.

The repulsion approach has often involved coatings containing toxic materials, such as organotin compounds and copper compounds, discussed in U.S. Pat. No. 6,559,201. Such compounds may leach into the environment, reducing the effectiveness of the coating and polluting the environment.

Existing non-toxic antifouling coatings which seek to reduce the ability of marine organisms and/or slime to adhere to the surface have proved only moderately effective.

Some existing compositions have required the application or more than one layer thereof, to the substrate to be protected.

There is an ongoing need for an antifouling coating which is safe to apply, effective across a worthwhile time span and is acceptable from a safety and an environmental standpoint.

In accordance with a first aspect of the present invention there is provided a coating composition for coating a structure which is subject to damage from water the coating composition comprising (1) a cross-linkable polysiloxane; (2) a silane cross-linking agent; and (3) fumed silica.

Preferably the composition is curable to give a coating comprising a polymer matrix.

Preferably the composition does not comprise an aluminium component or a glass component.

By aluminium component is meant either aluminium metal, or a water-insoluble aluminium compound, for example aluminium oxide or an aluminium silicate.

By glass component is meant a particulate glass component comprising glass that has been particulated. This includes any kind of glass, including high-quartz glass (sometimes called just “quartz sand”), borosilicate glass, or soda-lime glass.

In this specification, a cross-linkable polysiloxane has the general formula:

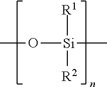

where R¹ and R² may be any hydrocarbyl group optionally substituted, or a further siloxane branch in accordance with the above structure, and n may be any integer greater than 2. R¹ and R² are preferably the same, and are preferably they are selected from hydroxyl groups and branched or unbranched alkyl radicals. Preferably they are branched or unbranched alkyl radicals.

Preferably the cross-linkable polysiloxane (1) is hydroxy-terminated. Preferably a hydroxy-terminated siloxane has at least one free hydroxyl group in the molecule, preferably attached to a terminal silicon atom.

The cross-linkable siloxane preferably has a dynamic viscosity of at least 10 poise (P) (1 Pascal-seconds, Pa·s), more preferably at least 30 P (30 Pa·s), more preferably at least 50 P (at least 50 Pa·s), more preferably at least 100 P (10 Pa·s). In some embodiments it may be at least 250 P (25 Pa·s), more preferably at least 400 P (40 Pa·s).

The cross-linkable siloxane preferably has a dynamic viscosity of no more than 1000 P (100 Pa·s), preferably no more than 750 P (75 Pa·s), most preferably no more than 600 P (60 Pa·s). In some embodiments it may be no more than 400 P (40 Pa·s), more preferably no more than 200 P (20 Pa·s), more preferably no more than 100 P (10 Pa·s).

In some preferred embodiments the cross-linkable siloxane has a dynamic viscosity in the range 30-100 P (3-10 Pa·s), most preferably 40-80 P (4-8 Pa·s).

Viscosity definitions herein refer to a Brookfield viscometer, using spindle No. 1, at 22.5° C. at a speed of 60 rpm at a torque setting of 36.2%.

Preferably the silane cross-linking agent (2) is an oxime silane, preferably selected from one or more of: methyltris(methylethylketoxime)silane, methyltris(acetoxime)silane, methyltris(methylisobutylketoxime) silane, dimethyldi(methylethylketoxime)silane, trimethyl(methyl ethylketoxime)silane, tetra(methylethylketoxime)silane, tetra(methylisobutylketoxime)silane, vinyltris(methylethyl ketoxime)silane, methylvinyldi(methylethylketoxime)silane, methylvinyldi(cyclohexanoneoxime)silane, vinyltris(methyl isobutylketoxime)silane, phenyltris(methylethylketoxime) silane, methylisobutylketoxime (MIBKO) and acetoxime (dimethylketoxime).

A preferred cross-linking silane is a vinyl oximino silane, a methyl oximino silane, or a mixture thereof.

Preferably the silane cross-linking agent (2) is an oxime silane which on reaction releases no or only a small amount of methylethylketoxime (MEKO). Especially preferred are methyltri(oxime) silanes and vinyltri(oxime) silanes.

Preferably the cross-linking silane renders the composition curable.

Preferably the at least one silane chemically cross-links the cross-linkable siloxane when curing the composition. This has the advantage that the composition is stable on storage, and during application, so as to remain either sprayable or spreadable.

In embodiments of the invention components (1) and (2) may react together without assistance from a catalyst. In other embodiments a catalyst may be employed.

A suitable catalyst is a silanol condensing catalyst.

A preferred catalyst is a compound (or compounds) selected from the group consisting of a metal carboxylate, a carboxylic acid ester metal salt, a metal carboxylate polymer, a metal carboxylate chelate, a titanic ester and titanic ester chelate. These catalysts have good catalytic activity. Examples of such catalysts include tin (I) acetate, dibutyl tin dilaurate, dibutyl tin dioctate, dibutyl tin diacetate, dioctyl tin dilaurate, dioctyl tin dioctate, dioctyl tin diacetate, tin (I) dioctanate, lead naphthenate, cobalt naphthenate, iron 2-ethyl hexenoic acetate, dioctyl tin bis-octyl thioglycollic acid ester salt, dioctyl tin maleic acid ester salt, dibutyl tin maleic acid polymer, dimethyl tin mercapto propionic acid salt polymer, dibutyl tin bis-acetyl acetonate, dioctyl tin bis-acetyl laurate, tetrabutyl titanate, tetranonyl titanate and bis-(acetylacetonyl)di-propyltitanate. Tin catalysts are especially preferred.

Preferably the components defined in the first aspect are present in the following proportions by weight:
1 part fumed silica (3), to:
5 to 400 parts (preferably 10 to 250 parts, preferably
20 to 100 parts, most preferably 30 to 50 parts) cross-linkable polysiloxane (1);
and to
0.3 to 30 parts (preferably 1 to 20 parts, preferably 2 to 10 parts, most preferably 3 to 6 parts) silane cross-linking agent (2).

When amounts are stated they refer to the total complement of a stated component. For example if there are two silane cross-linking agents the 1 to 30 parts reference is to the total thereof, not to each agent on its own.

Fumed silica (3) used in this invention can be (3a) fumed silica treated with a polysiloxane (e.g. as defined above), for example with polydimethylsiloxane. Alternatively it may be (3b) fumed silica not treated with a polysiloxane. Most preferably the fumed silica includes a fumed silica (3a) which is not treated with polysiloxane admixed with fumed silica (3b) which is treated with polysiloxane; the relative proportions thereof by weight preferably being in the range 5 to 95 parts (3a) to 95 to 5 parts (3b); preferably 30 to 90 parts (3a) to 70 to 10 parts (3b); preferably 50 to 8 parts (3a) to 50 to 20 parts (3b). Preferably fumed silica (3a) is present in excess over fumed silica (3b), by weight. Preferably the weight ratio is 60 to 80 parts (3a) to 40 to 20 parts (3b).

The fumed silica is believed to increase tensile strength and improve toughness, and to improve water repellency of the surface. It does not have a detrimental effect on application of the composition.

These benefits can be obtained using a fumed silica, whether or not treated it has been treated with a polysiloxane. Using a fumed silica (3a) which has not been treated with polysiloxane is cost effective but in such embodiments admixing fumed silica (3a) with fumed silica (3b) which has been treated with polysiloxane is beneficial, in aiding good dispersion in the composition. It is believed that the polysiloxane present in fumed silica (3b) promotes compatibility between fumed silica particles and the matrix material.

Different amounts or grades of fumed silica, in particular different particle sizes, may give different surface finishes, from gloss (which is generally preferred) to matt.

When a catalyst is present it may be present in a weight ratio of, preferably, 0.001 to 0.5 parts catalyst, preferably 0.005 to 1 parts catalyst, per 1 part fumed silica (3).

Preferably the composition includes a silane adhesion promoter. Preferably the silane adhesion promoter is a different chemical compound to the silane cross-linking agent. However it is not excluded that one silane compound could perform both functions.

Preferably a silane adhesion promoter is selected from an aminosilane, a vinyl silane, an epoxy silane and a methacryl silane. A preferred silane adhesion promoter is aminoethyl aminopropyl trimethoxy silane.

The silane adhesion promoter need not be present in a large amount. Suitably the weight ratio of the fumed silica (3) to the silane adhesion promoter, when present, is in the range 1 part fumed silica (3) to 0.1 to 10 parts (preferably 0.2 to 4 parts, most preferably 0.3 to 1 part) silane adhesion promoter.

Preferably the composition comprises a polysiloxane softener and/or plasticiser. The polysiloxane is preferably different from the cross-linkable polysiloxane (1) mentioned above. Most preferably it is a polysiloxane oil.

The softener and/or plasticizer may be a siloxane, preferably a non-hydroxy-terminated siloxane. The non-hydroxy-terminated siloxane is preferably a polydialkylsiloxane. Suitable siloxane polymers or oligomers may include dimethylpolysiloxane, diethylpolysiloxane, diphenylpolysiloxane, dimethoxypolysiloxane, diethoxypolysiloxane, dimethylpolysiloxane ethoxylate, poly[methyl(3,3,3-trifluoropropyl)siloxane], hexamethyldisiloxane, hexaethyldisiloxane, hexaphenyldisiloxane, 1,1,3,3-tetramethyldisiloxane, 1,1,3,3-tetraethyl-disiloxane, 1,1,3,3-tetraisopropyldisiloxane, 1,3-diethoxy-1,1,3,3-tetramethyldisiloxane, 1,3-dimethyltetravinyldisiloxane, pentamethyldisiloxane, 1,1,1-trimethyl-3,3,3-triphenyldisiloxane, 1,1,1-triphenyl-3,3,3-tris(m-tolyl)-disiloxane, 1,3-dimethyl-1,1,3,3-tetraphenyldisiloxane, 1,1,3,3-tetramethyl-1,3-diphenyldisiloxane, 1,3-dibenzyl-1,1,3,3-tetramethyldisiloxane, 1,3-dimethyltetramethoxydi siloxane, octamethyltrisiloxane, 1,1,1,3,5,5,5-heptamethyl trisiloxane, 1,1,3,3,5,5-hexamethyltrisiloxane, decamethyl tetrasiloxane, 1,1,1,3,5,7,7,7-octamethyltetra siloxane.

The non-hydroxy-terminated siloxane preferably comprises no cross-linkable moieties, and preferably no free hydroxyl groups.

The non-hydroxy-terminated siloxane preferably has a viscosity of at least 1 poise (P) (0.1 Pascal-seconds, Pa·s), more preferably at least 5 P (0.5 Pa·s), most preferably at least 9 P (0.9 Pa·s). Preferably the viscosity is no more than 100 P (10 Pa·s), more preferably no more than 50 P (5 Pa·s), and most preferably no more than 11 P (1.1 Pa·s).

The at least one silane preferably comprises at least one leaving group, and more preferably at least two leaving groups. The at least one leaving group preferably comprises a group whose conjugate acid has a pKₐ in water of between 8 and 17, preferably between 9 and 15, preferably between 11 and 13. The at least one leaving group may comprise a moiety selected from the group including aryloxy, haloalkoxy, oxime, ketooxime. The at least one silane may comprise a ketoxime silane.

Suitable adhesion promoting silanes may include tetraethyl silane, tetraallyl silane, tetraphenyl silane, tetrakis(3-fluorophenyl)silane, tetrakis(p-tolyl)silane, ethyltriacetoxysilane, isobutyl(trimethoxy)silane, triacetoxy(vinyl)silane, triethoxy(ethyl)silane, triethyl(trifluoromethyl)silane, trimethoxy(vinyl)silane, trimethyl(phenyl)silane, N-beta-(aminoethyl)-gamma-amino-propylmethyldimethoxysilane, trimethyl(vinyl)silane, tris(2-methoxyethoxy)(vinyl)silane, methyltris(dimethylketoxime)silane, 1-phenyl-2-trimethyl silylacetylene, 3-trimethylsiloxy-1-propyne, 3-[tris(trimethylsiloxy)silyl]propyl methacrylate, allyl(4-methoxyphenyl)dimethylsilane, butyldimethyl(dimethylamino) silane, diisopropyl(3,3,4,4,5,5,6,6,6-nonafluorohexyl)silane, dimethoxy-methyl(3,3,3-trifluoropropyl)silane, vinyltrimethoxysilane.

In some embodiments the polysiloxane softener and/or plasticiser, when present, is present in an amount of from 1 to 40 parts (preferably 2 to 20 parts, preferably 4 to parts) polysiloxane softener and/or plasticiser to 1 part fumed silica, by weight.

In some embodiments the polysiloxane softener and/or plasticiser, when present, is present in an amount of from 0.1 to 100 parts (preferably 0.5 to 50 parts, preferably 1 to 10 parts) polysiloxane softener and/or plasticiser to 100 parts fumed silica, by weight

Preferably the composition comprises a pigment. In principle any colour could be employed, but black or blue colours are preferred. Preferably the pigment is present in an amount of from 1 to 40 parts (preferably 2 to 20 parts, preferably 4 to 15 parts) pigment to 1 part fumed silica (by weight).

The composition is preferably “slippy” to the touch when in the form of a dried coating on a substrate. Preferably the composition is curable upon the surface to give a substantially non-stick hydrophobic coated surface such that water dropped onto the coated surface forms beads, which may readily run off it when it is tilted by 15° from the horizontal. Preferably a bead of water on a coated surface which is horizontal has a contact angle of at least 90°, preferably at least 120°.

In preferred embodiments the composition contains a solvent or carrier which evaporates to leave the final matrix. Preferred solvents or carriers are alkanes, preferably C₁₁ to C₁₅ alkanes, and alkanols, preferably C₁ to C₁₂ alcohols, preferably C₁ to C₄ alcohols; for example isopropanol. When present a solvent or carrier may constitute 0.5 to 80 parts (preferably 0.5 to 40 parts, preferably 1 to 20 parts, preferably 1 to 10 parts) per 1 part fumed silica, by weight.

Preferably the coating composition, when laid down, has not more than 20% solvent, preferably not more than 10% solvent, preferably not more than 5% solvent. Especially preferred embodiments are solvent-free.

Preferably the coating composition is substantially water-free.

Compositions may be sprayable and in such embodiments may require a high amount of solvent, for example at least 40% of the as-sprayed composition weight; preferably 40-60% of the composition weight. However compositions are preferably spreadable by means of an implement such as a roller or brush. Preferably the viscosity of the composition (before curing) is in the range 5000-10000 cP (5-10 Pa·s), preferably 7000-10000 cP (7-10 Pa·s).

A structure which is subject to damage by water may be a structure which is immersed in water, for example the hull of a boat or ship, or the submerged parts of an oil rig, or a structure which is lapped by water or immersed cyclically, for example by the action of waves or tides.

Preferably the coating prevents fouling on underwater or water-challenged structures; and preferably those from the group including boats, ships, submarines, submarine oil field facilities, underwater tunnels, pipelines, jetties, breakwaters, groynes, buoys, bridges, water treatment plants and power stations.

According to a second aspect of the present invention there is provided a liquid coating composition comprising:
20 to 98.5% w/w (preferably 40 to 90% w/w, preferably 60 to 80% w/w) hydroxy terminated polydimethylsiloxane (1) (as cross-linkable matrix material)
1 to 15% w/w silane cross-linking agent (2)
0.5 to 5% w/w fumed silica (3)
optionally, 2 to 25% w/w non-hydroxy terminated polydimethyl siloxane (as softener and/or plasticiser)
optionally, up to 20% w/w alkanes (solvent).

The coating may undergo curing in air once applied.

According to a third aspect of the present invention there is provided a coated substrate wherein the coating thereon comprises at least one layer of the composition of either of the first or second aspect.

The coating may comprise more than one layer of the composition. The coating may be applied in one pass, or preferably one or more passes. However the coating is preferably applied in not more than three passes; and once preferably in one or two passes only.

When there is more than one pass there is no necessity to apply the later layer(s) within a particular time after application of the previous layer. In embodiments of the invention it is acceptable for a later layer to be applied after an earlier layer has fully cured (or before, if wished).

The thickness of the final coating is preferably between 15 microns to 1000 microns, more preferably between 50 microns to 500 microns, and most preferably between 75 microns and 200 microns.

According to a fourth aspect of the present invention there is provided a method of preparing a coating composition as defined in any previous aspect, comprising mixing together a hydroxy-terminated cross-linkable siloxane and at least one cross-linking silane and fumed silica to form the composition.

A fifth aspect of the present invention involves a method of preparing a coated substrate of the third aspect, comprising:
a) applying the coating composition of the first or second aspect over a surface by an application means to form a layer;
b) optionally applying one or more further layers of coating; and
c) curing the said coating(s).

Preferably the substrate to be treated is clean (for example grease free) and without corrosion damage (for example perforations or crusting).

The composition is suitable for the treatment of any surface, though a surface would preferably be selected from the group: fibreglass, metal alloys (including aluminium/aluminium alloy), wood, painted surfaces, conventional antifouling paint, and rubber bitumen.

Preferably the method further comprises applying the coating composition onto the coating(s). As noted above this could be done by spraying or spreading (e.g. brush or, preferably, roller), but spreading is preferred and means that a low- or no-solvent composition can be used.

Preferably the curing process is moisture activated in air as a result of the moisture content of the atmosphere. Preferably the applied coating(s) are left to cure for 12 hours, preferably for at least 24 hours, and preferably for at least 72 hours in some embodiment. Preferably there is at least 4 hours between each coating application, more preferably at least 8 hours, and most preferably at least 12.

Preferably such compositions may tolerate temperatures from −40° C., preferably from −60° C., to 500° C. after curing. More preferably the compositions tolerate temperatures between −60° C. to 280° C. Preferably the compositions substantially retain their hydrophobicity, and preferably retain their flexibility, between −60° C. to 280° C.

According to a sixth aspect of the present invention there is provided a method of protecting underwater structures, comprising preparing a coated substrate in accordance with the fifth aspect.

Applied correctly, the coatings herein disclosed should last for at least 5 years, more likely at least 10 years and most likely at least 20 years.

On static underwater structures the propensity of organisms and soils to adhere to the surface is reduced. The frequency of cleaning can be reduced and cleaning requires minimal effort.

The same is true on mobile underwater structures, but an additional benefit may occur: fouling may be washed off by movement through the water. A boat or ship may in effect become self-cleaning. Alternatively cleaning may be carried out when structures are out of the water, and may be carried out for example by mild rubbing or by hosing down or spraying.

Preferred features of any aspect are also preferred features of any other aspect.

The invention will now be further described with respect to the following examples.

### EXAMPLE 1

A hydrophobic coating composition was made by blending the following components:
67% w/w hydroxy terminated polydimethylsiloxane
12% w/w non-hydroxy terminated polydimethylsiloxane
3% w/w methyloximinosilane (cross-linking agent)
1.2% w/w vinyloximinosilane (cross-linking agent)
1.2% w/w fumed silica (mechanical properties enhancer)
0.6% w/w fumed silica treated with PDMS (mechanical properties enhancer and dispersion aid)
1% w/w aminoethylaminopropyltrimethoxysilane (adhesion promoter)
2% w/w isoparaffinic solvent
12% w/w black pigment.
The pigment and fumed silica are particulates. The other components are liquids.

The components were blended and then packaged in airtight paint tins, with the intention of later roller application from the tins onto a suitable substrate, e.g. a boat hull.

The hydroxy-terminated polydimethylsiloxane (PDMS) has a viscosity of 60 P (6 Pa·s) and serves as the foundation of the composition and is cross-linked on curing by the oximinosilanes present.

The non-hydroxy terminated polydimethylsiloxane has a viscosity of 10 P (1 Pa·s) and is a plasticizer which allows a flexible substrate coated with the above composition to be flexed without cracking the coating.

The adhesion promoter which helps the composition initially adhere to a substrate to be coated before curing takes place.

The isoparaffinic solvent acts as a diluent or thinning agent to provide the composition with a consistency conducive to spreadability.

In use, the thickness of a typical coating after application of two layers and curing in air is 150 to 400 microns. The composition feels “slippy” and is not wetted by water: water dropped onto the coated substrate held horizontally forms beads; inclining the substrate even a small amount, e.g. 15% causes the beads to run off the surface.

Coatings formed from the composition are resistant to bio-fouling in marine environments. Such fouling as does form is poorly adhered and can be quickly removed, for example, by mild rubbing or by hosing off or spraying with water. Application of a second such coating, if wished, is easily achieved; the first and second coatings bond well together.

### EXAMPLE 2

A hydrophobic coating composition was made by blending the following components:
38 Kg hydroxy terminated polydimethylsiloxane
8 Kg non-hydroxy terminated polydimethylsiloxane
3.5 Kg methyloximinosilane (cross-linking agent)
0.8 Kg vinyloximinosilane (cross-linking agent)
0.75 Kg fumed silica (mechanical properties enhancer)
0.35 Kg fumed silica treated with PDMS (mechanical properties enhancer and dispersion aid)
0.35 Kg aminoethylaminopropyltrimethoxysilane (adhesion promoter)
87 Kg C11-C15 isoparaffinic solvent

The components are as employed in Example 1. The composition differs from that of Example 1 in having of a large amount of solvent, and in the absence of a pigment.

The Example 2 composition is clear and the cured coating thereof is clear.

The components were blended and used as described in Example 1, except that spraying could be used as an application method.

### EXAMPLE 3

A hydrophobic coating composition was made by blending the following components:
82 Kg hydroxy terminated polydimethylsiloxane
16 Kg non-hydroxy terminated polydimethylsiloxane
7.5 Kg methyloximinosilane (cross-linking agent)
1.7 Kg vinyloximinosilane (cross-linking agent)
2.2 Kg fumed silica
0.34 Kg aminoethylaminopropyltrimethoxysilane (adhesion promoter)
15 Kg C11-C15 isoparaffinic solvent
11 Kg dark blue pigment.

The pigment and fumed silicas are particulates. The other components are all liquid.

The components were blended and used as described in Example 1.

### EXAMPLE 4

A hydrophobic coating composition was made by blending the following components:
115 Kg hydroxy terminated polydimethylsiloxane
2 Kg methyl tri(oximino) silane (cross-linking agent)
9 Kg vinyl tri(oximino)silane (cross-linking agent)
5 Kg hexamethyldisilazane-aftertreated fumed silica
1 Kg aminoethylaminopropyltrimethoxysilane (adhesion promoter)
0.12 Kg dioctyl tin dilaurate (catalyst for cross-linking reaction)
0.12 Kg non-hydroxy terminated polydimethyl-siloxane oil. This functions as a plasticiser and as a carrier; it is mixed with the catalyst to ease dispersion of catalyst into the composition.
118 Kg C11-C15 isoparaffinic solvent.

The Example 4 composition is clear and the cured coating thereof is clear.

The components were blended and used as described in Example 1, except that spraying could be used as an application method.

### EXAMPLE 5

A hydrophobic coating composition was made by blending the following components:
227 Kg hydroxy terminated polydimethylsiloxane
2.5 Kg methyl tri(oximino) silane (cross-linking agent)
11.6 Kg vinyl tri(oximino)silane (cross-linking agent)
6.3 Kg hexamethyldisilazane-aftertreated fumed silica
2.5 Kg aminoethylaminopropyltrimethoxysilane (adhesion promoter)
0.12 Kg dioctyl tin dilaurate (catalyst for cross-linking reaction)
0.12 Kg non-hydroxy terminated polydimethylsiloxane oil. This functions as a plasticiser and as a carrier; it is mixed with the catalyst to ease dispersion of catalyst into the composition.

The components were blended and used as described in Example 1.

### EXAMPLE 6

A hydrophobic coating composition was made by blending the following components:
108 Kg hydroxy terminated polydimethylsiloxane
2 Kg methyl tri(oximino) silane (cross-linking agent)
10 Kg vinyl tri(oximino)silane (cross-linking agent)
6 Kg hexamethyldisilazane-aftertreated fumed silica
1 Kg aminoethylaminopropyltrimethoxysilane (adhesion promoter)
0.12 Kg dioctyl tin dilaurate (catalyst for cross-linking reaction)
0.12 Kg non-hydroxy terminated polydimethylsiloxane oil. This functions as a plasticiser and as a carrier; it is mixed with the catalyst to ease dispersion of catalyst into the composition.
118 Kg C11-C15 isoparaffinic solvent
5 Kg isopropanol.

The Example 6 composition is clear and the cured coating thereof is clear.

The components were blended and used as described in Example 1, except that spraying could be used as an application method.

### EXAMPLE 7

A hydrophobic coating composition was made by blending the following components:
213 Kg hydroxy terminated polydimethylsiloxane
2.5 Kg methyl tri(oximino) silane (cross-linking agent)
11.6 Kg vinyl tri(oximino)silane (cross-linking agent)
6.3 Kg hexamethyldisilazane-aftertreated fumed silica
2.5 Kg aminoethylaminopropyltrimethoxysilane (adhesion promoter)
0.12 Kg dioctyl tin dilaurate (catalyst for cross-linking reaction)
37 Kg non-hydroxy terminated polydimethylsiloxane oil/plasticiser (0.12 Kg of which was mixed with the catalyst to ease dispersion of catalyst into the composition).

The Example 7 composition is clear and the cured coating thereof is clear.

The components were blended and used as described in Example 1.

Compositions in accordance with the invention have been tested by being applied to the hulls of vessels under confidential conditions, and used in salt-water environments for periods of (to date) approximately one year. Results have been outstanding, when assessed by any measure, including: ease of application; quality of application attained even when application has been non-professional (and thus, inexpensive); the mechanical properties obtained, including the resistance to scratches and chips; and the ability of the surface to resist contamination by marine flora (including algae) and fauna (for example barnacles).

1. A coating composition for coating an underwater structure which is subject to damage from water, the coating composition comprising:
a cross-linkable polysiloxane;
a silane cross-linking agent; and
fumed silica.

2. The coating composition of claim 1, wherein the silane cross-linking agent chemically cross-links the cross-linkable siloxane upon curing the composition.

3. The coating composition of claim 1, wherein the cross-linkable polysiloxane is a hydroxy-terminated polydialkylsiloxane.

4. The coating composition of claim 1, wherein the components are present in the following proportions by weight:
1 part fumed silica, to:
5 to 400 parts cross-linkable polysiloxane; and
0.3 to 30 parts silane cross-linking agent.

5. The coating composition of claim 1, wherein the fumed silica is selected from one or both of fumed silica treated with a polysiloxane, and fumed silica not treated with a polysiloxane.

6. The coating composition as claimed in claim 5, wherein the fumed silica includes fumed silica which is not treated with polysiloxane admixed with fumed silica which is treated with polysiloxane; the relative proportions thereof by weight preferably being in the range 5 to 95 parts fumed silicon which is not treated with polysiloxane to 95 to 5 parts fumed silica which is treated with polysiloxane.

7. The coating composition of claim 1, wherein the fumed silica includes relative proportions by weight of 50 to 80 parts fumed silica not treated with polysiloxane to 50 to 20 parts fumed silica treated with polysiloxane.

8. The coating composition of claim 1, further comprising a silane adhesion promoter, which is a different chemical compound than the silane cross-linking agent.

9. The coating composition of claim 1, further comprising a polysiloxane softener and/or plasticiser, which is a different chemical compound to the cross-linkable polysiloxane.

10. The coating composition of claim 1, wherein the composition is solvent-free.

11. The coating composition of claim 1, wherein a viscosity of the composition, before curing, is in the range 3000-10000 cP.

12. The coating composition of claim 1, which is a liquid coating composition comprising:
20 to 98.5% w/w, hydroxyl-terminated polydimethyl siloxane as cross-linkable matrix material;
1 to 15% w/w silane cross-linking agent;
0.5 to 5% w/w fumed silica.

13. A coated substrate immersed in use in water, wherein the coating comprises at least one layer of the composition as claimed in claim 1.

14. A method of preparing a coated substrate as claimed in claim 13, comprising:
a) applying the coating composition of claim 1 over a surface to form a layer; and
b) curing or permitting the curing of the said coating.

15. A method of providing resistance to fouling on an immersed surface of a marine structure, the method comprising preparing a coated substrate as claimed in claim 14.

16. The coating composition of claim 12, further comprising:
2% to 25% by weight non-hydroxy terminated polydimethyl siloxane.

17. The method of claim 14, further comprising:
applying one or more further layers of the coating composition.
